(19) United States
(12) Patent Application Publication
(10) Pub. No.: US 2021/0107459 A1
(43) Pub. Date: Apr. 15, 2021

(54) PARKING ASSIST SYSTEM

(71) Applicant: TOYOTA JIDOSHA KABUSHIKI KAISHA, Toyota-shi (JP)

(72) Inventors: Atsushi TOJO, Toyota-shi (JP); Yuki Minase, Toyota-shi (JP)

(73) Assignee: TOYOTA JIDOSHA KABUSHIKI KAISHA, Toyota-shi (JP)

(21) Appl. No.: 16/989,346

(22) Filed: Aug. 10, 2020

(30) Foreign Application Priority Data
Oct. 11, 2019 (JP) 2019-187479

(51) Int. Cl. B60W 30/06; B60R 16/023; B60W 50/12

(52) U.S. Cl. CPC B60W 30/06; B60W 50/12; B60R 16/0231

(57) ABSTRACT

The vehicle parking assist system includes a parking assist ECU configured to set a first driving-force limit value during the execution of the parking assist control, and a drive ECU connected to the parking assist ECU for communication, and configured to control the driving force of the drive apparatus of the vehicle. While the drive ECU successfully receives the first driving-force limit value from the parking assist ECU, the drive ECU controls the driving force of the drive apparatus so that the driving force of the drive apparatus is prevented from exceeding the first driving-force limit value. When the communication abnormality has occurred, and a driver-request driving force directed to the drive apparatus becomes 0, the drive ECU controls the driving force of the drive apparatus so that the driving force of the drive apparatus thereafter is the driver-request driving force.

### BACKGROUND OF THE INVENTION

### 1. Field of the Invention

The present invention relates to a parking assist system configured to execute parking assist of moving a vehicle to a specified parking position.

### 2. Description of the Related Art

In Japanese Patent Application Laid-open No. 2007-118804, there is disclosed a parking assist system configured to execute parking assist of moving a vehicle to a specified parking position. In Japanese Patent Application Laid-open No. 2007-118804, there is disclosed a configuration in which the parking assist system includes a parking assist ECU (referred to as “driving assist ECU” in Japanese Patent Application Laid-open No. 2007-118804) and a drive ECU (referred to as “accelerator control ECU” therein). Further, during the parking assist, the parking assist ECU provides assist information to the drive ECU, and the drive ECU controls a drive apparatus based on the provided assist information, to thereby move a vehicle. A driving force of the drive apparatus is limited so that the vehicle is accurately moved to the specified parking position during the execution of the parking assist control. Specifically, the parking assist ECU is configured to set a driving-force limit value to transmit the driving-force limit value to the drive ECU. The drive ECU is configured to control the drive apparatus so that the driving force of the drive apparatus is prevented from exceeding the received driving-force limit value regardless of a driver-request driving force.

Further, in Japanese Patent Application Laid-open No. 2007-118804, there is disclosed a configuration in which a depressing operation by the driver on a brake pedal is used as a finish condition (cancellation condition) for the parking assist. With this parking assist system, cancellation or continuation of the driving assist operation against an intention of the driver can be prevented.

Incidentally, a controller area network (CAN) is sometimes used for transmission and reception of signals among apparatus mounted to the vehicle, for example, ECUs. In this case, the parking assist ECU transmits assist information to the drive ECU through the CAN. With this configuration, when the drive ECU becomes unable to receive the assist information from the parking assist ECU due to communication failure of the CAN or the like during the parking assist, the control for the drive apparatus based on the driving-force limit value set by the parking assist ECU becomes difficult. Therefore, in this case, it is preferred to quickly finish the parking assist.

However, hitherto, a parking assist system has been configured to continue the parking assist when a cancellation condition for the parking assist is not satisfied (that is, when the cancellation operation is not executed). With this configuration, even when the drive ECU cannot receive the assist information from the parking assist ECU, the parking assist and accompanying driving force limiting control (control of preventing the driving force of the drive apparatus from exceeding the driving-force limit value regardless of the driver-request driving force) continue until the cancellation operation of the parking assist is executed. Therefore, even when the driver tries to move the vehicle in order to execute the cancellation operation for the parking assist, for example, even when the driver tries to move the vehicle to a location at which the vehicle does not obstruct traffic around the vehicle, the driving force limiting control continues, and the vehicle cannot thus be quickly moved.

### SUMMARY OF THE INVENTION

The present invention has been made in view of the above-mentioned problem. That is, an object of the present invention is to provide a parking assist system capable of quickly moving a vehicle through a driving force in accordance with a driver-request driving force when communication abnormality occurs during execution of parking assist.

According to at least one embodiment of the present invention, there is provided a parking assist system (1), which is configured to execute parking assist control for moving a vehicle (100) to a set target parking position, the parking assist system including: a driving-force limit value setter (10) configured to set a first driving-force limit value, which is an upper limit value of a driving force of a drive apparatus (23) of the vehicle (100), each time a set period of time elapses during the execution of the parking assist control; and a drive apparatus controller (11), which is connected so as to be communicable with the driving-force limit value setter (10), and is configured to control the driving force of the drive apparatus (23) the vehicle (100), wherein the drive apparatus controller (11) is configured to: control the driving force of the drive apparatus (23) so that the driving force of the drive apparatus (23) is prevented from exceeding the first driving-force limit value during a period of time in which the first driving-force limit value set by the driving-force limit value setter (10) is successfully received; and control the driving force of the drive apparatus (23) so that, when a state, in which the first driving-force limit value is unable to be received from the driving-force limit value setter (10), continues for a predetermined period of time, and when the driver-request driving force directed to the drive apparatus becomes 0, the driving force of the drive apparatus (23) becomes a driver-request driving force.

According to the parking assist system of at least one embodiment of the present invention, the driving force of the drive apparatus (23) is the driving force in accordance with the driver-request driving force when the state, in which the first driving-force limit value set by the driving-force limit value setter (10) cannot be received, continues for the predetermined period of time, and the driver-request driving force directed to the drive apparatus (23) then becomes 0. Therefore, when communication abnormality occurs between the driving-force limit value setter (10) and the drive apparatus controller (11), the driver can quickly move the vehicle (100) even during the execution of the parking assist.

In at least one aspect of the present invention, the driving-force limit value setter (10) and the drive apparatus controller (11) may be configured to be connected to each other through a CAN.

In at least one aspect of the present invention, the drive apparatus controller (11) may be configured to: set, when the first driving-force limit value becomes unable to be received from the driving-force limit value setter (10), a second driving-force limit value, which is an upper limit value of the driving force of the drive apparatus (23); and control the driving force of the drive apparatus (23) so that the driving force of the drive apparatus (23) is prevented from exceeding the second driving-force limit value during a period of time in which a predetermined period of time elapsed since the first driving-force limit value becomes unable to be received from the driving-force limit value setter (10).

According to the at least one aspect of the present invention, when the first driving-force limit value becomes unable to be received from the driving-force limit value setter (10), the drive apparatus controller (11) sets the upper limit value of the driving force of the drive apparatus (23) so that the state in which the driving force of the drive apparatus (23) is limited is maintained. Thus, when the first driving-force limit value becomes unable to be received from the driving-force limit value setter (10), the behavior of the vehicle (100) is prevented from becoming unstable.

In at least one aspect of the present invention, the drive apparatus controller (11) is configured to set the first driving-force limit value received from the driving-force limit value setter (10) last time as the second driving-force limit value.

According to the at least one aspect of the present invention, a rapid change in vehicle speed is prevented when the first driving-force limit value becomes unable to be received from the driving-force limit value setter (10). Thus, when the first driving-force limit value becomes unable to be received from the driving-force limit value setter (10), the behavior of the vehicle (100) is prevented from becoming unstable.

In at least one aspect of the present invention, the drive apparatus controller (11) is configured to: set a third driving-force limit value when a predetermined period of time elapses since the first driving-force limit value becomes unable to be received from the driving-force limit value setter; and control the driving force of the drive apparatus (23) so that the driving force of the drive apparatus (23) is prevented from exceeding the third driving-force limit value during a period of time in which a predetermined period of time elapsed since the first driving-force limit value becomes unable to be received from the driving-force limit value setter (10), and until the driver-request driving force becomes 0.

According to the at least one aspect of the present invention, even when the predetermined period of time elapses after the first driving-force limit value becomes unable to be received from the driving-force limit value setter (10), the behavior of the vehicle (100) is prevented from becoming unstable.

In at least one aspect of the present invention, the third driving-force limit value may be a minimum required driving force for travel of the vehicle (100).

According to the at least one aspect the present invention, when the predetermined period of time elapses after the first driving-force limit value becomes unable to be received from the driving-force limit value setter (10), the speed of the vehicle (100) can be reduced. Therefore, the travel of the vehicle (100) can be suppressed until, for example, the driver executes a certain operation.

In the above description, in order to facilitate understanding of the present invention, a name and/or reference numeral used in the embodiment of the present invention is enclosed in parentheses and assigned to each of the constituent features of the present invention corresponding to the embodiment. However, each of the constituent features of the present invention is not limited to the embodiment defined by the name and/or reference numeral.

### BRIEF DESCRIPTION OF THE DRAWINGS

FIG. 1 is a schematic configuration diagram of a parking assist system according to at least one embodiment of the present invention.

FIG. 2 is a flowchart for illustrating an example of processing of a parking assist ECU.

FIG. 3 is a flowchart for illustrating an example of processing of a drive ECU.

FIG. 4 is a chart for showing transitions of a communication state, a driver-request driving force, and a driving force set by the drive ECU.

### DESCRIPTION OF THE EMBODIMENTS

Description is now given of a parking assist system according to at least one embodiment of the present invention with reference to the drawings. For the convenience of description, the parking assist system according to at least one embodiment of the present invention is sometimes abbreviated as “apparatus of this embodiment”. The apparatus of this embodiment is applied to a vehicle including a drive apparatus.

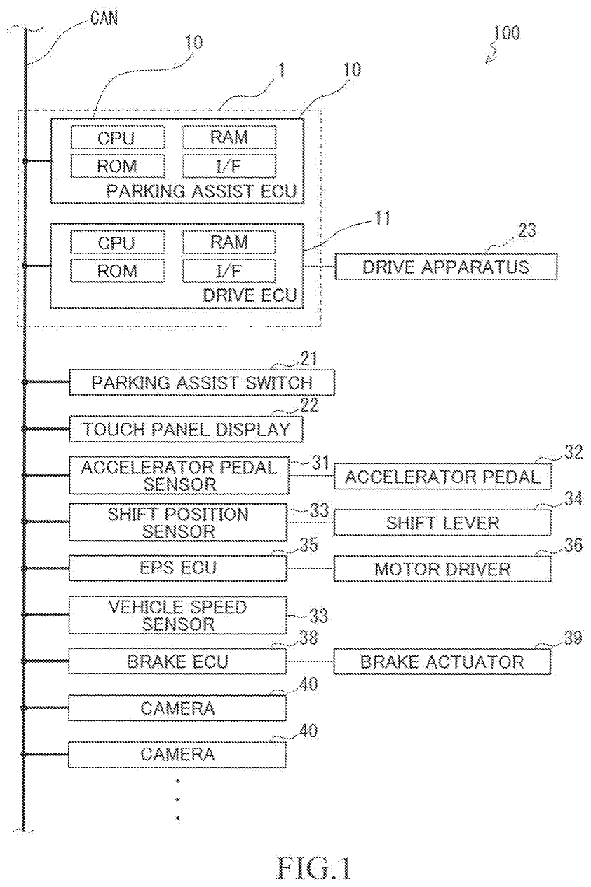

FIG. 1 is a diagram for schematically illustrating a configuration example of a vehicle 100 to which the apparatus 1 of this embodiment is applied. As illustrated in FIG. 1, the apparatus 1 of this embodiment includes a parking assist ECU 10 and a drive ECU 11. The parking assist ECU 10 corresponds to a driving-force limit value setter in the present invention. The drive ECU 11 corresponds to a drive apparatus controller in the present invention. Each of the parking assist ECU 10 and the drive ECU 11 includes a computer. The computer includes a CPU, a ROM, a RAM, and an I/F. Moreover, the parking assist ECU 10 and the drive ECU 11 are connected to each other for communication through a controller area network (CAN). Further, sensors, cameras 40, and ECUs of the vehicle 100 are also connected to one another for communication through the CAN. Therefore, each of the ECUs can acquire various types of information detected by each of the sensors and images taken by each of the cameras 40 through the CAN.

When a start condition for parking assist control is satisfied, the parking assist ECU 10 starts the parking assist control. When a finish condition for the parking assist control is satisfied, the parking assist ECU 10 finishes the parking assist control. During the execution of the parking assist control, the parking assist ECU 10 transmits a drive command to the drive ECU 11 at predetermined cycles, and transmits a steering command to an EPS ECU 35 at predetermined cycles.

The drive ECU 11 is connected to the drive apparatus 23 of the vehicle 100, and is configured to control the drive apparatus 23, which is a source of a driving force used for the travel of the vehicle 100. For example, when the vehicle 100 includes an engine (internal combustion engine) as the drive apparatus 23, the drive ECU 11 is connected to an engine actuator, and is configured to drive this engine actuator so that a driving force generated by the engine can be changed. When the vehicle 100 includes a motor (electric motor) as the drive apparatus 23, the drive ECU 11 is connected to a motor driver configured to drive this motor, and is configured to drive this motor driver so that a driving force generated by the motor can be changed. When the vehicle 100 is a hybrid vehicle including an engine and a motor as the drive apparatus 23, the drive ECU 11 is configured to drive an engine actuator and a motor driver so that a driving force of the drive apparatus 23 can be controlled.

A parking assist switch 21 is a switch operable by a driver, for example. Moreover, the parking assist ECU 10 can detect an operation on the parking assist switch 21. The vehicle 100 may include an ECU configured to detect the operation on the parking assist switch 21, which is not shown in FIG. 1. In this case, the parking assist ECU 10 can detect through this ECU that the parking assist switch 21 has been operated. Moreover, the parking assist switch 21 may directly be connected to the parking assist ECU 10. In brief, the parking assist ECU 10 is only required to be able to detect the operation on the parking assist switch 21.

A touch panel display 22 is an apparatus configured to be able to display an image, and to be able to receive an operation. The vehicle 100 may include an ECU configured to control the touch panel display 22, which is not shown in FIG. 1. In this case, the parking assist ECU 10 transmits a control command for the touch panel display 22 to this ECU, and detects the operation on the touch panel display 22 through this ECU. Moreover, the touch panel display 22 may be directly connected to the parking assist ECU 10. In brief, the parking assist ECU 10 is only required to be able to display images, operation menus, operation icons (operation buttons), and the like relating to the parking assist control on the touch panel display 22, and to be able to detect the operation on the touch panel display 22. The images and the like displayed on the touch panel display 22 include operation menus and operation icons for setting, for example, a target parking position, and a “start” icon (button) for receiving a command for starting the parking assist.

An accelerator pedal sensor 31 is configured to detect an operation amount of an accelerator pedal 32. In the apparatus 1 of this embodiment, the operation amount of the accelerator pedal 32 corresponds to a driver-request driving force.

A shift position sensor 33 is configured to be able to detect a position (shift position) of a shift lever 34. The shift positions include a parking position (P), a drive position (D), and a reverse position (R).

The EPS ECU 35 is a control apparatus of a widely-known electric power steering system. The EPS ECU 35 is connected to a motor driver 36, and is configured to control the motor driver 36 configured to drive a steering motor (not shown). The steering motor is configured to use electric power supplied by the motor driver 36 to generate torque, and to be able to use this torque to generate a steering assist torque, to thereby steer left and right steered wheels. Moreover, when the EPS ECU 35 receives the steering command from the parking assist ECU 10 during the parking assist control, the EPS ECU 35 can automatically (that is, without requiring a steering operation by the driver) change a steering angle of the vehicle 100 based on the received steering command.

A vehicle speed sensor 37 is configured to detect a speed (vehicle speed) of the vehicle 100 to output a signal indicating the vehicle speed.

The plurality of cameras 40 are configured to be able to take images of areas around the vehicle 100. The plurality of cameras 40 include, for example, a front camera, a back camera, a right-side camera, and a left-side camera. The front camera is configured to take a front view of the vehicle 100. The back camera is configured to take a rear view of the vehicle 100. The right-side camera is configured to take a right view of the vehicle 100. The left-side camera is configured to take a left view of the vehicle 100. The vehicle 100 may include an ECU configured to control the plurality of cameras 40, and the plurality of cameras 40 may be connected to this ECU. Moreover, the plurality of cameras 40 may be connected to the parking assist ECU 10.

Description is now given of an overview of the parking assist control executed by the apparatus 1 of this embodiment. The parking assist control executed by the apparatus 1 of this embodiment is control of automatically or semi-automatically moving the vehicle 100 to a target parking position set by the driver, for example.

The apparatus 1 of this embodiment starts the parking assist control when the start condition is satisfied. For example, when the parking assist ECU 10 detects the operation on the parking assist switch 21 under a state in which the vehicle 100 is stopped (the vehicle speed detected by the vehicle speed sensor 37 is 0), the parking assist ECU 10 displays the operation icon (operation button) for setting the target parking position and the “start” icon (button) for starting the parking assist control on the touch panel display 22. After that, when the parking assist ECU 10 detects an operation for setting the target parking position on the touch panel display 22, and then detects a touch operation on the “start” icon, the parking assist ECU 10 starts the parking assist control. As described above, in the apparatus 1 of this embodiment, when the target parking position is set, and the touch operation is executed on the “start” icon, it is assumed that the start condition is satisfied.

When the parking assist ECU 10 starts the parking assist control, the parking assist ECU 10 uses the images of areas around the vehicle 100 taken by the cameras 40 and the like to identify a current position of the vehicle 100 and the target parking position each time a predetermined period of time (set period) elapses (for example, cyclically), and calculates a path (that is, a target path) for allowing the vehicle 100 to move from the current position to the target parking position without contacts of the vehicle 100 with obstacles and the like. Moreover, the parking assist ECU 10 sets a first driving-force limit value, which is an upper limit value of the driving force of the drive apparatus 23, a target braking force of brakes, and a target steering angle of a steering apparatus, transmits the set first driving-force limit value to the drive ECU 11, transmits the set target braking force to a brake ECU 38, and transmits the set target steering angle to the EPS ECU 35 each time a predetermined period of time (set period) elapses (for example, cyclically) so that the vehicle 100 moves along the calculated target path. A specific value of the first driving-force limit value is not particularly limited, and, for example, a driving force larger than a driving force during idling is applied. When the vehicle 100 includes a shift-by-wire system, the parking assist ECU 10 sets the shift position, and transmits the set shift position to an ECU (SWB ECU) configured to control a shift actuator (actuator configure to switch the shift position). When the vehicle 100 has a configuration in which the driver executes a shift operation, the parking assist ECU 10 executes processing of notifying the driver of the set shift position (processing of prompting the driver to execute the shift operation).

The drive ECU 11 controls the driving force of the drive apparatus 23 so that the driving force of the drive apparatus 23 is prevented from exceeding the received first driving-force limit value. The brake ECU 38 drives the brake actuator 39 so that the braking force of the brakes is the received target braking force. The EPS ECU 35 controls the motor driver 36 so that the steering angle of the steering apparatus is the received target steering angle. When the vehicle 100 includes the shift-by-wire system, the SWB ECU drives the shift actuator so that the shift position of the shift mechanism is the received shift position.

The above-mentioned parking assist control itself is publicly known (for example, see Japanese Patent Application Laid-open No. 2017-21427, Japanese Patent Application Laid-open No. 2017-138664, and Japanese Patent Application Laid-open No. 2018-127065).

Moreover, each ECU of the apparatus 1 of this embodiment continuously (cyclically) executes the above-mentioned processing each time a predetermined period of time elapses until the finish condition for the parking assist control is satisfied. In the apparatus 1 of this embodiment, when the start condition for the parking assist control is temporarily satisfied, the vehicle speed detected by the vehicle speed sensor 37 becomes 0 after that, and the shift position detected by the shift position sensor 33 is brought to the parking position (P), it is determined that the finish condition is satisfied. The parking assist control has been summarized above.

When the vehicle speed becomes high during the parking assist control, it becomes difficult to accurately move the vehicle 100 along the target path. Thus, when the apparatus 1 of this embodiment starts the parking assist control, the apparatus 1 of this embodiment limits the driving force of the drive apparatus 23. Specifically, as described above, the parking assist ECU 10 sets the first driving-force limit value, and transmits the set first driving-force limit value to the drive ECU 11. After that, the drive ECU 11 controls the drive apparatus 23 so that the driving force of the drive apparatus 23 is prevented from exceeding the first driving-force limit value received from the parking assist ECU 10 regardless of the driver-request driving force. Thus, while the driving force is limited, even when the driver operates the accelerator pedal 32, an operation amount of this operation is not reflected in the vehicle speed, and the vehicle speed is limited to a vehicle speed in accordance with the first driving-force limit value set by the parking assist ECU 10.

However, with the configuration in which the parking assist ECU 10 and the drive ECU 11 transmit and receive the signals through the CAN, when the drive ECU 11 becomes unable to receive the first driving-force limit value from the parking assist ECU 10 due to communication failure of the CAN or the like, it becomes difficult for the drive ECU 11 to appropriately control the driving force of the drive apparatus 23. Therefore, in this case, it is preferred to quickly finish the parking assist control to execute transition to a state in which the operation of the driver is received. In this case, the driver sometimes tries to move the vehicle 100 to, for example, a location at which the vehicle does not obstruct traffic around the vehicle 100, and then finish the parking assist control. However, it is required that the finish condition be satisfied to finish the parking assist control, and, in order to satisfy the finish condition, for example, the driver is required to stop the vehicle 100 and then switch the shift position to the parking position (P). That is, the driving force of the drive apparatus 23 is limited until the cancellation operation is executed, and even when the driver tries to move the vehicle 100 in order to execute the cancellation operation for the parking assist control, the driver cannot quickly move the vehicle 100.

Thus, when communication abnormality occurs between the parking assist ECU 10 and the drive ECU 11, the apparatus 1 of this embodiment finishes the driving force limiting control even when the finish condition for the parking assist control is not satisfied. As a result, even when the finish condition for the parking assist control is not satisfied, the vehicle 100 can be caused to travel in accordance with the driver-request driving force.

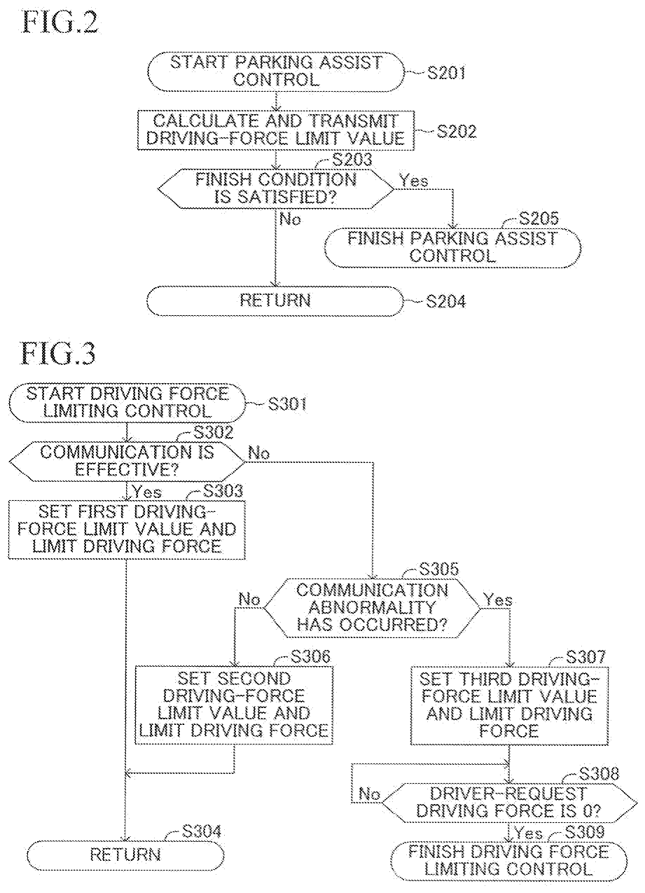

Description is now given of details of the parking assist control. The control of the brake, the steering, and the shift mechanism is only required to be the same as that of related art, and description thereof is therefore omitted. FIG. 2 is a flowchart for illustrating an example of processing executed by the parking assist ECU 10. A computer program for executing the processing illustrated in FIG. 2 is stored in advance in the ROM of the parking assist ECU 10, and the CPU of the parking assist ECU 10 reads out this computer program from the ROM, and loads the computer program onto the RAM and executes the computer program. As a result, the processing illustrated in FIG. 2 is executed.

When the start condition for the parking assist control is satisfied, the apparatus 1 of this embodiment starts the parking assist control (Step S201). The start condition for the parking assist control is as described above.

In Step S202, the parking assist ECU 10 calculates the path (that is, the target path) along which the vehicle 100 can be moved from the current position of the vehicle 100 to the target parking position without contacts with obstacles and the like. Moreover, the parking assist ECU 10 sets the first driving-force limit value, and transmits the set first driving-force limit value to the drive ECU 11 through the CAN.

In Step S203, the parking assist ECU 10 determines whether or not the finish condition for the parking assist control is satisfied. The finish condition for the parking assist control is as described above. When the finish condition is not satisfied (“No” in Step S203), the parking assist ECU 10 proceeds to Step S204, and temporarily finishes this processing.

After that, when the finish condition is not satisfied, the parking assist ECU 10 repeats the processing of Step S202 and Step S203 each time the predetermined period of time elapses. That is, the parking assist ECU 10 continues the parking assist processing until the finish condition for the parking assist processing is satisfied. While the parking assist processing is continued, the drive ECU 11 controls the drive apparatus 23 based on the first driving-force limit value set by the parking assist ECU 10 regardless of the operation amount of the accelerator pedal 32 of the driver. However, when the brake pedal is operated by the driver, the brake ECU 38 controls the brakes so that a braking force corresponding to an operation amount of this operation is generated. Even in a case in which the vehicle 100 is stopped through the operation of the brake pedal, when the operation amount of the brake pedal becomes zero after that, the control is resumed.

In Step S203, when the parking assist ECU 10 determines that the finish condition is satisfied (“Yes” in Step S203), the processing proceeds to Step S205, and the parking assist ECU 10 finishes the parking assist processing. When the parking assist processing is finished, the driving force limiting control is also finished. That is, after the parking assist processing is finished, the drive ECU 11 controls the driving force of the drive apparatus 23 in accordance with the driver-request driving force.

Description is now given of an example of the processing executed by the drive ECU 11. FIG. 3 is a flowchart for illustrating the example of processing executed by the drive ECU 11.

When the parking assist ECU 10 starts the parking assist control (Step S201 of FIG. 2), the drive ECU 11 starts the driving force limiting control (Step S301). The driving force limiting control refers to a state in which the driving force of the drive apparatus 23 is limited so that the driving force of the drive apparatus 23 is prevented from exceeding the first driving-force limit value set by the parking assist ECU 10, or a second driving-force limit value or a third driving-force limit value described later regardless of the driver-request driving force (operation amount of the accelerator pedal 32).

In Step S302, the drive ECU 11 determines whether the communication to/from the parking assist ECU 10 is effective or ineffective. In at least one embodiment, the state “the communication is effective” refers to a state in which the first driving-force limit value can be received from the parking assist ECU 10. The state “the communication is ineffective” refers to a state in which the first driving-force limit value is not received (cannot be received) from the parking assist ECU 10. When the communication is effective (“Yes” in Step S302), the processing proceeds to Step S303.

In Step S303, the drive ECU 11 controls the driving force of the drive apparatus 23 so that the driving force of the drive apparatus 23 is prevented from exceeding the first driving-force limit value received from the parking assist ECU 10 regardless of the driver-request driving force (in the apparatus 1 of this embodiment, the operation amount of the accelerator pedal 32 detected by the accelerator pedal sensor 31). After that, the processing proceeds to Step S304, and the drive ECU 11 temporarily finishes this processing.

The drive ECU 11 repeats the processing of Step S302 and Step S303 each time a set period of time (for example, 8 ms) elapses. That is, when the communication is effective, the drive ECU 11 repeats the processing of receiving the first driving-force limit value from the parking assist ECU 10, and controlling the driving force of the drive apparatus 23 so that the driving force is prevented from exceeding the received first driving-force limit value each time the set period of time elapses. Therefore, while the communication is effective after the start of the parking assist control, the driving force of the drive apparatus 23 is limited so as not to exceed the first driving-force limit value set by the parking assist ECU 10.

In Step S302, when the drive ECU 11 determines that the communication is ineffective (“No” in Step S302), the processing proceeds to Step S305. In Step S305, the drive ECU 11 determines whether or not the communication abnormality has occurred. In at least one embodiment, the state “the communication abnormality has occurred” refers to a continuation of the state in which the communication is ineffective for a predetermined period of time. The “predetermined period of time” is not particularly limited, and, for example, one second is applicable. When the drive ECU 11 determines that the communication abnormality has not occurred in Step S305, the processing proceeds to Step S306.

In Step S306, the drive ECU 11 sets the second driving-force limit value, which is an upper limit value of the driving force of the drive apparatus 23, and controls the driving force of the drive apparatus 23 so that the driving force of the drive apparatus 23 is prevented from exceeding the set second driving-force limit value regardless of the driver-request driving force. In the apparatus 1 of this embodiment, the first driving-force limit value received last time from the parking assist ECU 10 during the period of time of the effective communication is used as the second driving-force limit value. That is, the drive ECU 11 controls the drive apparatus 23 so that the driving force of the drive apparatus 23 is prevented from exceeding this “first driving-force limit value received last time”. After that, the processing proceeds to Step S304, and the drive ECU 11 temporarily finishes this processing.

As described above, when the communication becomes ineffective, “the drive ECU 11 repeats the processing of controlling the drive apparatus 23 so that the driving force of the drive apparatus 23 is prevented from exceeding ‘the first driving-force limit value received last time’” each time the predetermined period of time (set period) elapses. As described above, when the communication becomes ineffective, the drive ECU 11 sets the second driving-force limit value. Therefore, even when the communication becomes ineffective after the start of the parking assist control, the driving force of the drive apparatus 23 is limited so as not to exceed the second driving-force limit value set by the drive ECU 11.

In Step S305, when the drive ECU 11 determines that the communication abnormality has occurred (“Yes” in Step S305), the processing proceeds to Step S307.

In Step S307, the drive ECU 11 sets the third driving-force limit value. After that, the drive ECU 11 controls the driving force of the drive apparatus 23 so that the driving force of the drive apparatus 23 is prevented from exceeding the set third driving-force limit value regardless of the driver-request driving force. For example, the minimum required driving force (for example, the same driving force as that in idling) for the travel of the vehicle 100 is applicable to the third driving-force limit value. In this case, when the vehicle 100 is an AT vehicle, the vehicle 100 travels by creeping. As described above, when the communication abnormality occurs, the drive ECU 11 sets the third driving-force limit value, which is the upper limit value of the driving force of the drive apparatus 23 as in the case of the ineffective communication. Therefore, even when the communication abnormality occurs, the state in which the driving force of the drive apparatus 23 is limited is maintained. After that, the processing proceeds to Step S308.

In Step S308, the drive ECU 11 determines whether or not the driver-request driving force is 0. Specifically, the drive ECU 11 acquires the operation amount of the accelerator pedal 32 detected by the accelerator pedal sensor 31, and determines that the driver-request driving force is 0 when the acquired operation amount of the accelerator pedal 32 is 0. After that, the drive ECU 11 repeats this step until the drive ECU 11 determines that this driver-request driving force is 0. Thus, the driving force of the drive apparatus 23 is controlled so that the driving force is prevented from exceeding the third driving-force limit value until the driver-request driving force becomes 0.

When the drive ECU 11 determines that the driver-request driving force is 0 (“Yes” in Step S308), the processing proceeds to Step S309. In Step S309, the drive ECU 11 finishes the driving force limiting control. Thus, after that, even when the parking assist control is not finished (the finish condition is not satisfied), the drive ECU 11 drives the drive apparatus 23 in accordance with the driver-request driving force.

The EPS ECU 35 drives the motor driver 36 based on the steering information received from the parking assist ECU 10 until the finish condition for the parking assist control is satisfied even after the driving force limiting control is finished. That is, the EPS ECU 35 automatically (that is, without requiring the steering operation by the driver) changes the steering angle of the vehicle 100 based on the received steering command until the parking assist control is finished even after the driving force limiting control is finished. After that, when the parking assist control is finished (Step S205 of FIG. 2), the EPS ECU 35 finishes the automatic change in steering angle, and moves to a state in which the EPS ECU 35 changes the steering angle in accordance with the steering operation by the driver.

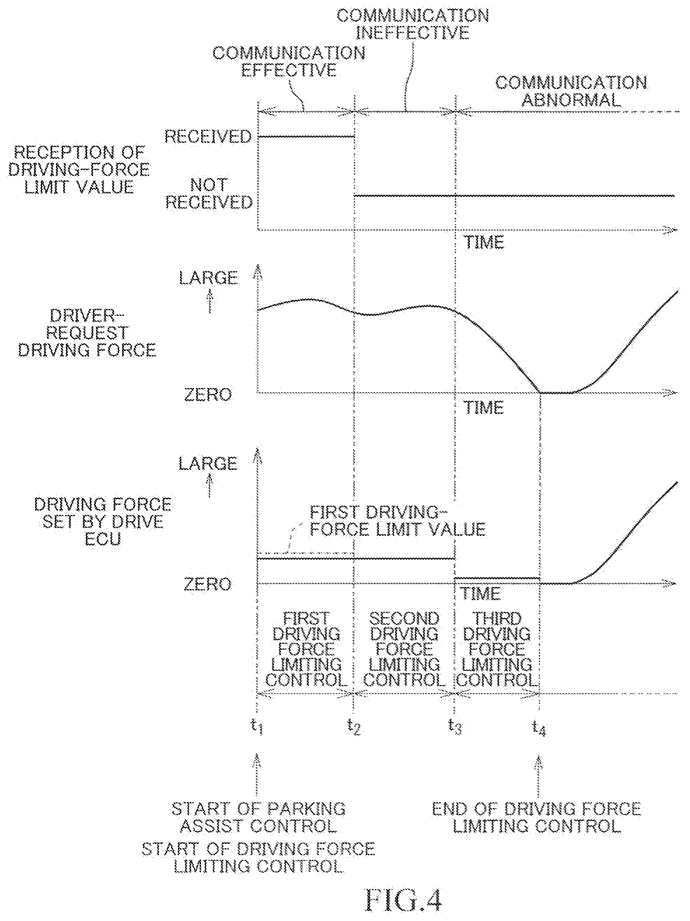

Description is now given of an example of the transition of the driving force set by the drive ECU 11. FIG. 4 is a chart for showing transitions of the communication state, the driver-request driving force, and the driving force set by the drive ECU 11. A timing t₁ of FIG. 4 indicates a timing of the start of the parking assist control. Moreover, a period of time from the timing t₁ to a timing t₂ is a period in which the drive ECU 11 can receive the first driving-force limit value from the parking assist ECU 10 (the communication is effective). A period of time after the timing t₂ is a period of time in which the drive ECU 11 cannot receive the first driving-force limit value from the parking assist ECU 10.

As described above, when the start condition for the parking assist control is satisfied, the parking assist ECU 10 repeats the processing of setting the first driving-force limit value and transmitting the first driving-force limit value to the drive ECU 11 (Step S202) each time the predetermined period of time elapses until the finish condition for the parking assist control is satisfied. Moreover, the drive ECU 11 repeats the processing of receiving the first driving-force limit value from the parking assist ECU 10 and controlling the driving force of the drive apparatus 23 so that the driving force is prevented from exceeding the received first driving-force limit value (Step S303 of FIG. 3) each time the predetermined period of time elapses (cyclically).

Therefore, as illustrated in FIG. 4, the driving force of the drive apparatus 23 is controlled so that the driving force is prevented from exceeding the first driving-force limit value received by the drive ECU 11 from the parking assist ECU 10 in the period of time from the timing t₁ to the timing t₂ in which the first driving-force limit value is received from the parking assist ECU 10.

When the drive ECU 11 becomes unable to receive the first driving-force limit value from the parking assist ECU 10 at the timing t₂, the drive ECU 11 determines that the communication is ineffective (“No” in Step S302 of FIG. 3). After that, the drive ECU 11 determines that the communication abnormality has not occurred (“No” in Step S305 of FIG. 3) until the predetermined period of time (period from the timing t₂ to the timing t₃) elapses after the timing t₂ at which the first driving-force limit value becomes unable to be received. Moreover, the driving force of the drive apparatus 23 is controlled so that the driving force is prevented from exceeding the second driving-force limit value (that is, the first driving-force limit value received last time by the drive ECU 11 from the parking assist ECU 10) set by the drive ECU 11 in this period of time from the timing t₂ to the timing t₃.

The drive ECU 11 determines that the communication abnormality has occurred (“Yes” in Step S305 of FIG. 3) when the predetermined period of time has elapsed from the timing t₂ at which the first driving-force limit value became unable to be received (timing t₃). After that, the driving force of the drive apparatus 23 is controlled so that the driving force is prevented from exceeding the third driving-force limit value (that is, the minimum required driving force for the travel of the vehicle 100) set by the drive ECU 11 from the timing t₃ to a timing t₄.

When the driver-request driving force becomes 0 at the timing t₄, the drive ECU 11 finishes the driving force limiting control. After the timing t₄, the drive ECU 11 drives the drive apparatus 23 in accordance with the driver-request driving force. Thus, the driver can operate the accelerator pedal 32 to accelerate the vehicle 100 even when the finish condition for the parking assist control is not satisfied.

As described above, the drive ECU 11 is configured to determine the state of the communication to/from the parking assist ECU 10, and to continue or to finish the driving force limiting control in accordance with the determination result. With this configuration, when the communication becomes ineffective during the execution of the parking assist control, the driver can quickly move the vehicle 100, and can then finish the parking assist control. That is, when the drive ECU 11 becomes unable to receive the first driving-force limit value from the parking assist ECU 10 during the parking assist control, the drive ECU 10 becomes unable to provide the control in which the driving force of the drive apparatus 23 is prevented from exceeding the first driving-force limit value set by the parking assist ECU 10. Therefore, in this case, it is preferred that the driver be allowed to quickly execute the finish operation for the parking assist control. For that purpose, it is preferred that the driver be allowed to quickly move the vehicle 100 to a location allowing the finish operation for the parking assist without a problem (for example, a location at which the vehicle 100 does not obstruct traffic around the vehicle 100).

However, in a related-art configuration, the driving force limiting control is continued, and the parking assist ECU 10 determines whether or not the finish condition for the parking assist control is satisfied during the parking assist control. Therefore, in the related-art configuration, even when the state in which the drive ECU 11 cannot receive the first driving-force limit value from the parking assist ECU 10 continues, the driving force limiting control is not finished. As a result, the driver cannot quickly move the vehicle 100 to a location allowing the finish operation for the parking assist without a problem.

In contrast, according to at least one embodiment, when the drive ECU 11 becomes unable to receive the first driving-force limit value from the parking assist ECU 10 during the parking assist control, the drive ECU 11 determines, regardless of the finish condition for the parking assist control, whether or not the driving force limiting control is to be finished. With this configuration, when the communication becomes ineffective, the driving force limiting control can be finished even when the parking assist control is not finished. Thus, in order to execute the finish operation (the operation of stopping the vehicle 100 and switching the shift position to the parking position (P)) for the parking assist control, the driver can quickly move the vehicle 100 to a location allowing the finish operation for the parking assist without a problem.

The drive ECU 11 finishes the driving force limiting control not only when the communication becomes abnormal, but also when the communication becomes abnormal and the driver-request driving force is 0. As a result, a sudden start or a sudden acceleration of the vehicle 100 can be prevented. That is, in a case in which the occurrence of the communication abnormality is the finish condition for the driving force limiting control, when the accelerator pedal 32 is operated at the timing of the occurrence of the communication abnormality, the driving force is generated in accordance with the amount of this operation, and there is a fear in that the vehicle 100 may suddenly start or may suddenly accelerate. In the apparatus 1 of this embodiment, both of the condition that the communication abnormality occurs and the condition that the driver-request driving force is 0 are set as the finish condition for the driving force limiting control, to thereby be able to prevent the sudden start or the sudden acceleration of the vehicle 100 when the communication abnormality occurs.

Moreover, when the drive ECU 11 becomes unable to receive the first driving-force limit value from the parking assist ECU 10, the drive ECU 11 sets the second driving-force limit value, which is the upper limit value of the driving force of the drive apparatus 23. After that, during the period of time in which the predetermined period of time elapses since the drive ECU 11 becomes unable to receive the first driving-force limit value from the parking assist ECU 10, the drive ECU 11 controls the driving force of the drive apparatus 23 so that the driving force of the drive apparatus 23 is prevented from exceeding the second driving-force limit value. Thus, when the drive ECU 11 becomes unable to receive the first driving-force limit value from the parking assist ECU 10, a behavior of the vehicle 100 is prevented from becoming unstable.

In this case, the drive ECU 11 sets the first driving-force limit value, which is received last time from the parking assist ECU 10 while the communication is effective, to the second driving-force limit value. With this configuration, the vehicle speed is prevented from rapidly changing when the drive ECU 11 becomes unable to receive the first driving-force limit value from the parking assist ECU 10. Thus, the behavior of the vehicle 100 is prevented from becoming unstable.

Moreover, when the predetermined period of time elapses after the drive ECU 11 becomes unable to receive the first driving-force limit value from the parking assist ECU 10, the drive ECU 11 sets the third driving-force limit value. When the predetermined period of time elapses after the drive ECU 11 becomes unable to receive the first driving-force limit value from the parking assist ECU 10, the drive ECU 11 controls the driving force of the drive apparatus 23 so that the driving force of the drive apparatus 23 is prevented from exceeding the third driving-force limit value. With this configuration, even when the predetermined period of time elapses after the drive ECU 11 becomes unable to receive the first driving-force limit value from the parking assist ECU 10, the behavior of the vehicle 100 is prevented from becoming unstable.

Moreover, in this case, the minimum required driving force for the travel of the vehicle 100 is applied as the third driving-force limit value. For example, the same driving force as that in the idling is applied as the third driving-force limit value. With this configuration, when the predetermined period of time elapses after the drive ECU 11 becomes unable to receive the first driving-force limit value from the parking assist ECU 10, the speed of the vehicle 100 can be reduced. Therefore, the travel of the vehicle 100 at high speed can be suppressed in a period of time until, for example, the drive executes a certain operation (for example, the operation on the accelerator pedal 32 or the operation on the brake pedal).

At least one embodiment of the present invention has been described, but the present invention is not limited to the above-mentioned at least one embodiment, and various modification examples based on the technical idea of the present invention may also be employed.

What is claimed is:

1. A parking assist system, which is configured to execute parking assist control for moving a vehicle to a set target parking position, the parking assist system comprising:
a driving-force limit value setter configured to set a first driving-force limit value, which is an upper limit value of a driving force of a drive apparatus of the vehicle, each time a set period of time elapses during the execution of the parking assist control; and
a drive apparatus controller, which is connected so as to be communicable with the driving-force limit value setter, and is configured to control the driving force of the drive apparatus,
wherein the drive apparatus controller is configured to:
control the driving force of the drive apparatus so that the driving force of the drive apparatus is prevented from exceeding the first driving-force limit value during a period of time in which the first driving-force limit value set by the driving-force limit value setter is successfully received; and
control the driving force of the drive apparatus so that, when a state, in which the first driving-force limit value is unavailable to be received from the driving-force limit value setter, continues for a predetermined period of time, and when a driver-request driving force directed to the drive apparatus becomes 0, the driving force of the drive apparatus becomes a driver-request driving force.

2. The parking assist system according to claim 1, wherein the driving-force limit value setter and the drive apparatus controller are connected to each other through a controller area network (CAN).

3. The parking assist system according to claim 1, wherein the drive apparatus controller is configured to:
set, when the first driving-force limit value becomes unable to be received from the driving-force limit value setter, a second driving-force limit value, which is an upper limit value of the driving force of the drive apparatus; and
control the driving force of the drive apparatus so that the driving force of the drive apparatus is prevented from exceeding the second driving-force limit value during a predetermined period of time elapsed since the first driving-force limit value becomes unable to be received from the driving-force limit value setter.

4. The parking assist system according to claim 3, wherein the drive apparatus controller is configured to set the first driving-force limit value received from the driving-force limit value setter last time as the second driving-force limit value.

5. The parking assist system according to claim 2, wherein the drive apparatus controller is configured to:
set a third driving-force limit value when a predetermined period of time elapses since the first driving-force limit value becomes unable to be received from the driving-force limit value setter; and
control the driving force of the drive apparatus so that the driving force of the drive apparatus is prevented from exceeding the third driving-force limit value during a period of time in which a predetermined period of time elapsed since the first driving-force limit value becomes unable to be received from the driving-force limit value setter, and until the driver-request driving force becomes 0.

6. The parking assist system according to claim 5, wherein the third driving-force limit value is a minimum required driving force for travelling of vehicle.
